(19) United States
(12) Patent Application Publication
(10) Pub. No.: US 2008/0103778 A1
(43) Pub. Date: May 1, 2008

(54) MOBILE TERMINAL HAVING FUNCTION FOR REPORTING CREDIT CARD LOSS AND METHOD USING SAME

(75) Inventors: Nak-Koo KIM, Seongnam-si (KR); Kyong-Joon Chun, Seoul (KR); Jee-Ah Kim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/928,947

(22) Filed: Oct. 30, 2007

(30) Foreign Application Priority Data
Oct. 31, 2006 (KR) 106371/2006

(51) Int. Cl. G10L 11/00

(52) U.S. Cl. 704/270.1; 704/E15.001

(57) ABSTRACT

Disclosed is a mobile terminal having a function for automatically conducting a credit card loss report. When a user selects a lost credit card from a credit card loss report menu, the mobile terminal accesses an Automated Response System (ARS) of the related credit card company and automatically conducts the credit card loss report. The mobile terminal analyzes each speech sentence in the ARS voice information to extract a speech pattern. The mobile terminal outputs a Dual Tone Multi-Frequency (DTMF) signal corresponding to the responses required by the ARS, and thereby automatically conduct the credit card loss report, which eliminates the need to enter all required responses manually.

### PRIORITY

This application claims priority to an application filed with the Korean Intellectual Property Office on Oct. 31, 2006 and assigned Serial No. 2006-0106371, the entire disclosure of which is hereby incorporated by reference.

### BACKGROUND OF THE INVENTION

1. Field of the Invention

The present invention relates to a mobile terminal having a function for reporting the loss of a credit card, and more particularly to a mobile terminal and method for accessing an automatic response system of a credit card company and automatically conducting a credit card loss report using speech recognition technology.

2. Description of the Related Art

When credit card holders lose their credit cards, they generally report the credit card loss to the credit card company using their mobile phones as quickly as possible in order to prevent unauthorized use of the credit cards.

FIG. 1 shows a general process of reporting the loss of a credit card. Upon recognizing the loss of a credit card, the credit card holder directly inputs a telephone number of a related credit card company or presses a corresponding shortcut key on a mobile phone (step S1) to access an Automated Response System (ARS) of the credit card company (step S2). After accessing the ARS, the card holder inputs user information required for eligibility verification purpose, such as a resident registration number or a credit card number (step S3). Then, the card holder reports the credit card loss according to the voice information provided by the ARS (step S4).

When reporting the loss by using a mobile phone, the card holder has to first access the ARS of the credit card company and then directly input all data required according to the voice information provided by the ARS. If a wallet containing two or more credit cards is lost or stolen, the card holder must repeat the loss report process in FIG. 1.

### SUMMARY OF THE INVENTION

Accordingly, the present invention has been made to solve the above-mentioned problems occurring in the prior art, and an aspect of the present invention is to provide a mobile terminal capable of accessing an ARS system of a credit card company and automatically conducting a credit card loss report without any input by a user.

In accordance with the present invention for accomplishing the above aspect, there is provided a mobile terminal having a function for reporting the loss of a credit card, the terminal includes a speech recognition unit for analyzing voice information provided by an ARS of a credit card company to extract a speech pattern of each speech sentence included in the voice information; a DTMF (Dual Tone Multi-Frequency) generator for outputting information required according to the ARS voice information in form of a DTMF signal; a memory for storing speech patterns of ARS voice information provided by at least one credit card company; and a control unit for comparing the speech pattern extracted by the speech recognition unit with the speech pattern stored in the memory, and controlling the DTMF generator to output a DTMF signal according to the voice information.

In accordance with another aspect of the present invention, there is provided a method for reporting the loss of a credit card using a mobile terminal, the method comprises storing speech patterns of voice information provided by an ARS of a credit card company; accessing the ARS and analyzing each speech sentence included in the voice information to extract a speech pattern thereof; comparing the extracted speech pattern with each stored speech pattern to recognize the voice information; and outputting information required according to the voice information in form of a DTMF signal.

In accordance with still another aspect of the present invention, there is provided a method for reporting the loss of a credit card using a mobile terminal, the method comprises displaying a list of credit cards; accessing an automated response system (ARS) of a corresponding credit card company when a lost credit card is selected from the displayed list; analyzing voice information provided by the accessed ARS; and outputting information required according to the ARS voice information in form of a DTMF signal in order to report the loss of the credit card.

### BRIEF DESCRIPTION OF THE DRAWINGS

The above and other aspects, features and advantages of the present invention will be more apparent from the following detailed description taken in conjunction with the accompanying drawings, in which:

FIG. 1 is a flowchart showing a conventional process of reporting the loss of a credit card using a mobile terminal;

FIG. 2 is a view showing the configuration of a system for reporting credit card loss using a mobile terminal according to the present invention;

FIG. 3 is a block diagram of a mobile terminal having a function for reporting credit card loss according to the present invention;

FIG. 4 is a flowchart showing a process of reporting the loss of a credit card using a mobile terminal according to the present invention;

FIG. 5 illustrates a user interface for conducting a credit card loss report according to the present invention; and

FIG. 6 is a flowchart showing the operation of a mobile terminal for reporting the loss of a credit card according to the present invention.

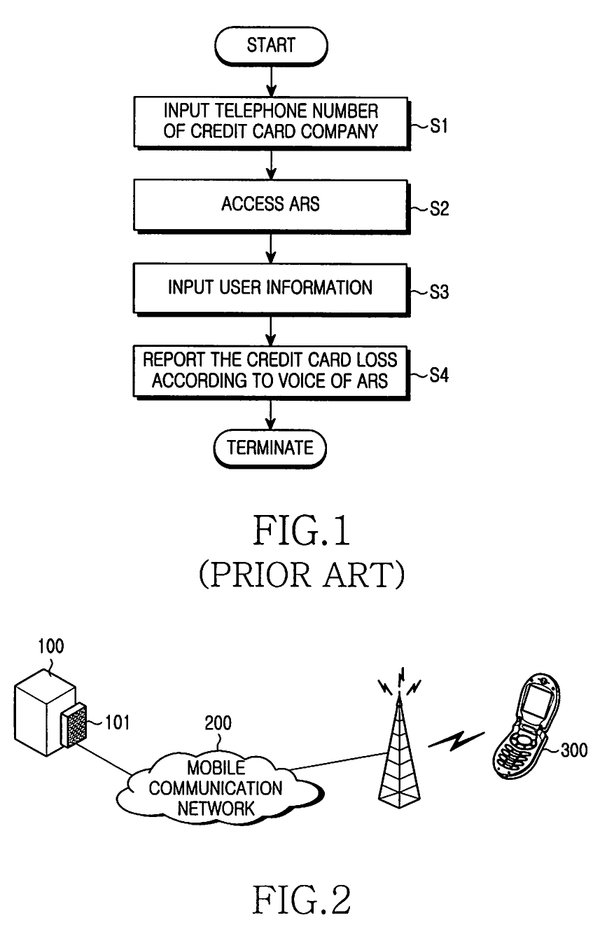

### DETAILED DESCRIPTION OF THE PREFERRED EMBODIMENT

Hereinafter, preferred embodiments of the present invention will be described with reference to the accompanying drawings.

FIG. 2 is a view showing the configuration of a system for reporting credit card loss using a mobile terminal according to the present invention.

Referring to FIG. 2, a user who lost a credit card may call a related credit card company 100 using a mobile terminal 200 in order to access an Automated Response System (ARS) 101 of the credit card company 100 through a mobile communication network 200. When the access is successful, the ARS 101 outputs voice information to the mobile terminal 200. In the prior art, the user has to listen to the ARS voice information outputted through a speaker of the mobile terminal 200 and input all data required, for example, a resident registration number or credit card number of the user, or a service selection number, by directly pressing keys on a keypad. According to the present invention, however, the mobile terminal 200 recognizes the voice information provided by the ARS, and automatically sends the required data to the ARS.

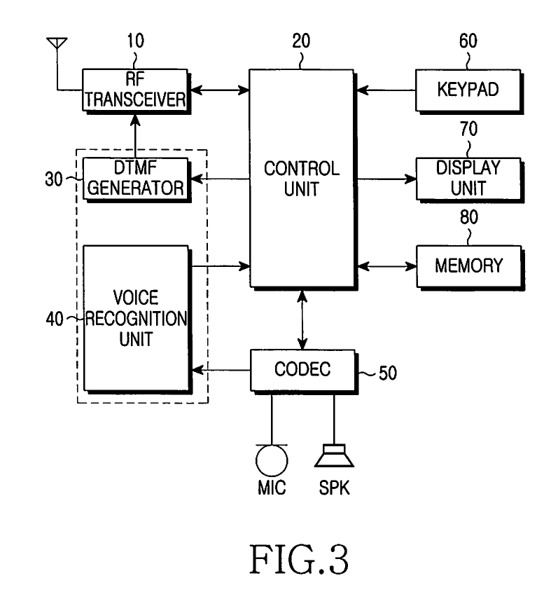

FIG. 3 is a block diagram of a mobile terminal having a function for reporting credit card loss according the present invention.

As shown in FIG. 3, the mobile terminal 300 includes an RF transceiver 10, a control unit 20, a DTMF generator 30, a speech recognition unit 40, a codec 50, a keypad 60, a display unit 70 and a memory 80. In the following description of the present invention, a detailed description of known functions and configurations incorporated herein will be omitted for clarity and conciseness.

The DTMF generator 30 generates and outputs a DTMF (Dual Tone Multi-Frequency) signal. More specifically, the DTMF generator 30 generates information required by the voice information of the ARS 101 in form of a DTMF signal, and outputs the generated DTMF signal to the RF transceiver 10.

The speech recognition unit 40 analyzes the ARS voice information outputted from the codec 50 to extract a speech pattern of each speech sentence included in the voice information. More specifically, the speech recognition unit 40 analyzes the waveform of each speech sentence in the ARS voice information based on the locations and spacing of the waveform peaks, length of a speech sentence and a Linear Predictive Coding (LPC) coefficient and extracts a speech pattern.

Since the speech recognition unit 40 analyzes the voice information of the ARS 101 to extract a rough speech pattern, rather than to recognize the exact content of the voice information, it can rapidly perform a speech recognition process with a simple hardware implementation.

The memory 80 stores speech patterns of ARS voice information provided by credit card companies. The user can directly download speech patterns of ARS voice information provided by each credit card company to the mobile terminal 300. Alternatively, the user can download the speech patterns from an Internet website of each credit card company to the mobile terminal 300 through a PC link.

The control unit 20 compares a speech pattern extracted by the speech recognition unit 40 with the speech pattern of ARS voice information of the corresponding credit card company, which is stored in the memory 80, in order to recognize the voice information. Then, the control unit 20 controls the DTMF generator 30 to generate a DTMF signal corresponding to the information required according to the recognized voice information.

In other words, the control unit 20 compares the speech pattern extracted by the speech recognition unit 40 with each stored speech pattern of the ARS voice information provided by the credit card company. If the extracted speech pattern is identical to a stored one in terms of the locations and spacing of speech waveform peaks, length of a speech sentence and an LPC coefficient, the control unit 20 will then control the DTMF generator 30 to output a DTMF signal corresponding to the information required. The control unit 20 repeats the process of controlling the output of a DTMF signal until the end of the ARS voice information.

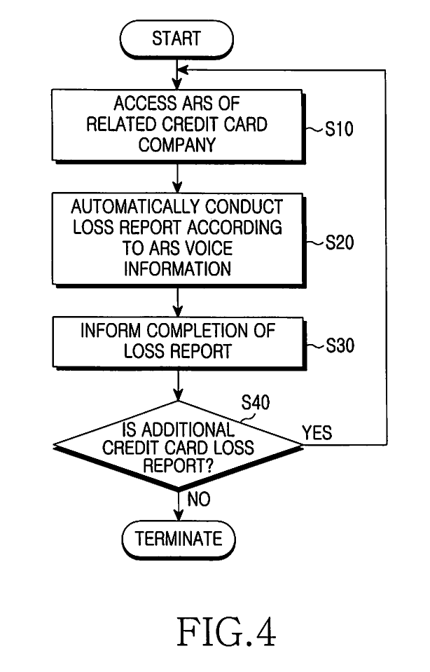

FIG. 4 is a flowchart showing a process of reporting the loss of a credit card using a mobile terminal according to the present invention.

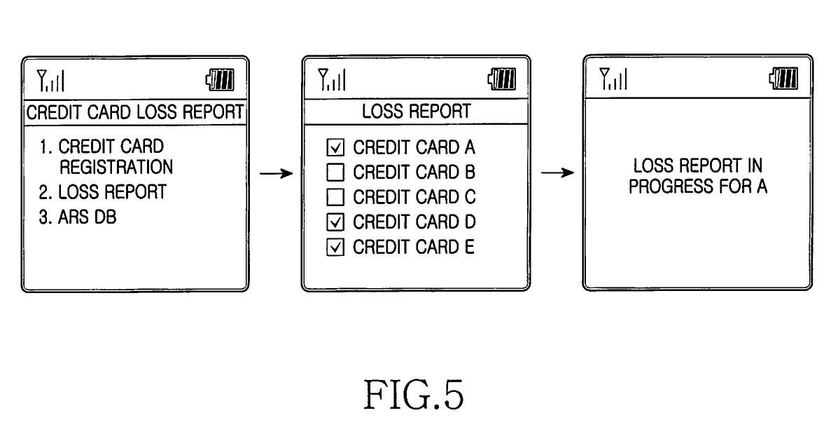

To report a credit card loss, the user accesses the ARS 101 of the related credit card company 100 using the mobile terminal 300 in step S10. According to a conventional method of accessing the ARS 101, the user has to enter a telephone number of the credit card company manually using the keys on the keypad 60 of the mobile terminal 300 or by pressing a shortcut key for selecting the telephone number stored in the memory 80. According to the present invention, however, the mobile terminal 300 provides a user interface as illustrated in FIG. 5 to access the ARS 101 of the credit card company and report the credit card loss.

As illustrated in FIG. 5, the mobile terminal 300 provides a menu for a credit card loss report. This menu contains items, such as credit card registration, loss report and ARS DB (DataBase). The user can select the credit card registration item to register credit card information (such as a credit card name, a credit card number, a resident registration number and a credit card company's telephone number), the loss report item to select a lost credit card and conduct a loss report, or the ARS DB item to register speech patterns of the ARS voice information provided by each credit card company.

When the loss report item is selected under the menu for a credit card loss report, the mobile terminal displays a list of credit cards. When the user selects a lost credit card from the displayed list and presses a preset key, the mobile terminal automatically accesses the ARS of a corresponding credit card company. When the access is successful, a message “Loss report in progress” can be displayed on the display unit 70.

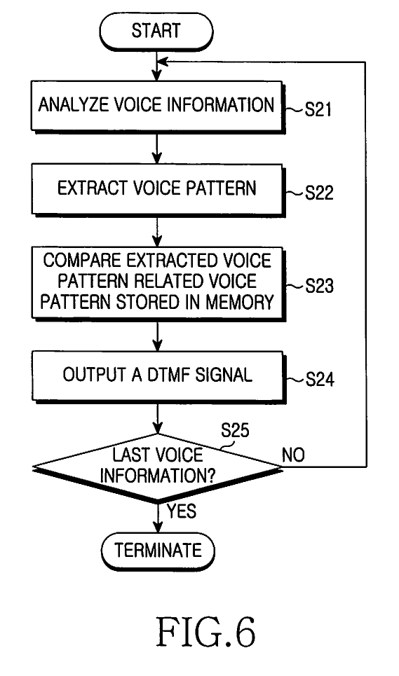

The mobile terminal 300 recognizes voice information provided by the ARS 101 and automatically conducts the loss report (FIG. 4) in step S20. The process of conducting the loss report in the mobile terminal 300 will be explained in further detail with reference to FIG. 6.

Upon completing the report of one lost credit card, the mobile terminal 300 outputs a message informing the completion of the loss report in step S30. At this time, the mobile terminal 300 can display the message on the display unit 70 or output a voice message through the speaker.

The mobile terminal determines whether the user selects another credit card to be reported in step S40. If an additional credit card is selected, the mobile terminal 300 will repeat the loss report process of steps S10, S20 and S30. If no additional credit card is selected, the mobile terminal 300 will terminate the loss report process.

Referring to FIG. 5, to report the loss of three credit cards (for example, credit card A, credit card D and credit card E), the user may first select credit card A from the displayed list of credit cards. Upon completion of the loss report for credit card A, the mobile terminal 300 outputs a message informing completion of the loss report for credit card A. Then the user may select credit card D. Upon completion of the loss report for credit card D, the user then selects credit card E so that the same process of loss report can be repeated for credit card E.

According to a preferred embodiment of the present invention, the mobile terminal outputs a message informing completion of the loss report whenever the loss report process for each credit card is completed. However, the mobile terminal can output the message after completing all processes of reporting the lost credit cards.

FIG. 6 is a flowchart showing the operation of a mobile terminal for reporting the loss of a credit card according to the present invention. When the mobile terminal 300 accesses the ARS 101 of the related credit card company 100, the speech recognition unit 40 analyzes voice information outputted from the ARS 101 in step S21. To be specific, the speech recognition unit 40 sequentially analyzes speech sentences included in the ARS voice information, and generates data, such as locations and spacing of waveform peaks of each speech sentence, length of a speech sentence, and an LPC coefficient, to extract a speech pattern of each speech sentence in step S22. Each extracted speech pattern is compared in real time with the speech patterns stored in the memory 80 in step S23). When an extracted speech pattern is identical to a stored one for a predetermined length of time, the mobile terminal 300 generates a DTMF signal corresponding to the information required according to the speech sentence at that point of time, and sends the generated signal to the ARS 101 in step S24).

The mobile terminal 300 determines whether a last speech sentence in the ARS voice information is outputted in step S25. If the mobile terminal 300 determines that the last speech sentence is outputted, it will terminate the credit card loss report. Otherwise, the mobile terminal 300 will repeat the steps of comparing speech patterns and sending a DTMF signal.

For example, it is assumed that ARS voice information provided by a credit card company states “Input your resident registration number or credit card number and press the * key”→“Press 1 for balance inquiry or 2 for loss report”→“The loss report was successfully received.” Upon recognizing the first speech sentence, the mobile terminal automatically generates and sends a DTMF signal corresponding to the user's resident registration number (or credit card number) and the * key. The mobile terminal recognizes the second speech sentence and at the same time determines that the second speech sentence is not the last. The mobile terminal automatically generates and sends a DTMF signal corresponding to the number key 2. Upon determining that the third speech sentence is the last one, the mobile terminal outputs a message informing completion of the loss report. Then the mobile terminal determines whether the user selects another credit card to be reported.

Although the DTMF generator has been explained as an independent element for convenience of explanation, it can be incorporated into the keypad.

As explained above, the user has only to select a lost credit card under the loss report menu. The mobile terminal according to the present invention automatically conducts a credit card loss report, eliminating the need for user to directly enter all data required by the ARS voice information.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A mobile terminal having a function for reporting a credit card loss, comprising:
a speech recognition unit for analyzing current voice information provided by an Automated Response System (ARS) of a credit card company to extract a current speech pattern of each current speech sentence included in the current voice information;
a Dual Tone Multi-Frequency (DTMF) generator for outputting responses required by the current voice information in form of a DTMF signal;
a memory for storing record speech patterns of related voice information provided by an ARS of at least one related credit company; and
a control unit for comparing the current speech pattern with the record speech patterns, and controlling the DTMF generator to output a DTMF signal according to the voice information when the current speech pattern is identical to one of the record speech patterns.

2. The mobile terminal according to claim 1, further comprising a user interface for outputting a message informing completion of the credit card loss report when recognizing a last speech sentence in the current voice information.

3. The mobile terminal according to claim 1, wherein the record speech patterns are downloaded through one of a wireless network and a computer, and stored in the memory.

4. A method for reporting a credit card loss by using a mobile terminal, comprising:
storing record speech patterns of related voice information provided by an Automated Response System (ARS) of at least one related credit card company;
accessing the ARS and analyzing each current speech sentence included in current voice information to extract a current speech pattern;
comparing the current speech pattern with each of the record speech patterns to recognize the current voice information; and
outputting responses required by the current voice information in form of a Dual Tone Multi-Frequency (DTMF) signal.

5. The method according to claim 4, further comprising outputting a message informing completion of the credit card loss report when recognizing a last speech sentence in the current voice information.

6. A method for reporting a credit card loss by using a mobile terminal, comprising:
displaying a list of related credit cards;
accessing a current Automated Response System (ARS) of a credit card company corresponding to a lost credit card selected from the list;
analyzing current voice information provided by the current ARS; and
outputting responses required by the current voice information in form of a Dual Tone Multi-Frequency (DTMF) signal in order to report the credit card loss.

7. The method according to claim 6, further comprising determining whether an additional lost credit card is selected.

8. The method according to claim 6, further comprising outputting a message informing completion of the credit card loss report when recognizing a last speech sentence in the current voice information.

9. The method according to claim 8, further comprising determining whether an additional lost credit card is selected.

10. The method according to claim 6, further comprising displaying a message informing the credit card loss report in progress during the process of the credit card loss report.
